(19) United States
(12) Patent Application Publication
(10) Pub. No.: US 2014/0344800 A1
(43) Pub. Date: Nov. 20, 2014

(54) DEVICE AND METHOD FOR DEVICE IDENTIFICATION AND FILE TRANSFER TO BACNET DEVICES

(71) Applicant: TRANE INTERNATIONAL INC., Piscataway, NJ (US)

(72) Inventors: Brian OHS, Oakdale, MN (US); Timothy James DISHOP, Roseville, MN (US); Scott STEFFES, Sartell, MN (US); Charles P. QUISTAD, North St. Paul, MN (US); Joel MONROE, Brooklyn Center, MN (US)

(73) Assignee: TRANE INTERNATIONAL INC., Piscataway, NY (US)

(21) Appl. No.: 14/282,621

(22) Filed: May 20, 2014

Related U.S. Application Data
(60) Provisional application No. 61/825,254, filed on May 20, 2013.

(51) Int. Cl. G06F 9/445; H04L 12/24

(52) U.S. Cl. CPC G06F 8/65; H04L 41/22
USPC 717/171

(57) ABSTRACT

A computerized service tool device and computer implemented method for performing an updating process for multiple unit controllers (UCs) of a HVAC system. The devices and methods include a graphical user interface (GUI) having one or more interactive elements for connecting to one or more devices of the HVAC system for performing the firmware updating process en masse.

### FIELD

This disclosure generally relates to a service tool devices and methods for controlling one or more devices connected to a network for controlling a building automation and control (BAC) system and/or a heating, ventilation, and air conditioning (HVAC) system.

### BACKGROUND

A BAC system having a building control network for a HVAC system can include a network using wired and/or wireless connections, interconnecting multiple networked control devices (e.g., controllers) for controlling various heating, ventilation, and air conditioning devices. A device connected in the HVAC system may be controlled by a Unit Controller (UC). One or more UC(s) may be connected to a System Controller (SC). The SC can control multiple UCs via a network, for example but not limited to, via a building automation and control networks (BACnet).

### SUMMARY

The embodiments disclosed are directed towards devices and methods for updating a firmware of one or more UC(s) using a computerized service tool device.

An embodiment of a computer device is configured to perform a data transfer process for firmware updating of one or more devices of a HVAC system. The computer device is a computerized service tool, comprising a processor, a display connected to the processor, a network interface connected to the processor, and a memory (e.g., a non-transitory memory) connected to the processor. The memory includes a firmware data for operation of one or more devices of the HVAC system, and computer-readable and processor executable computer instructions for displaying a graphical user interface (GUI) on the display device, wherein the GUI displays interactive elements for connecting to one or more devices of the HVAC system via the network interface for performing the firmware updating process on the one or more devices by transmitting the firmware data to the connected one or more devices.

An embodiment of a computer implemented method displays a graphical user interface (GUI) on a display device of a computer device for performing a firmware updating of one or more devices of a HVAC system. The method comprises displaying in the GUI, one or more interactive elements for selecting the one or more devices of the HVAC system, and displaying in the GUI, one or more interactive elements for performing the selecting the firmware updating process on the one or more devices of the HVAC system.

An embodiment of a computer implemented method for updating firmware of one or more unit controllers of a HVAC system comprises the steps of using a computerized service tool device to connect to a system controller of the HVAC system, accessing the system controller to retrieve identities of one or more unit controllers connected to the system controller via a network, transmitting one or more payload data from the computer service tool device to the system controller, and the system controller transmitting the one or more payload data to the one or more unit controllers and updating each of the firmware of the one or more unit controllers.

The embodiment of the method can also include transmitting an update schedule data from the computer service tool device to the system controller, wherein the transmission step is performed according to the update schedule data.

The embodiment of the method can also include, prior to the updating step, transmitting configuration data from one or more unit controllers to the computerized service tool device, and storing the configuration data to a memory of the computerized service tool device.

The embodiment of the method can also include, after the updating step, transmitting the configuration data from the computerized service tool device to one or more unit controllers, and storing the configuration data to a memory of the one or more unit controllers.

The embodiment of the method can also include, prior to the updating step, transmitting configuration data from one or more unit controllers to the system controller, and storing the configuration data to a memory of the system controller.

The embodiment of the method can also include, after the updating step, transmitting the configuration data from the system controller to one or more unit controllers, and storing the configuration data to a memory of the one or more unit controllers.

Another embodiment of the method for updating firmware of one or more unit controllers of a HVAC system comprises using a computerized service tool device to connect to a unit controller of the HVAC system, performing a discovery operation for identifying other unit controllers connected to the connected unit controller via a network, storing the identities of detected unit controllers to a memory of the computerized service tool device, and updating each of the firmware of the one or more unit controllers by transmitting one or more payload data from the computer service tool device to the one or more unit controllers.

The embodiment of the method can also include, prior to the updating step, transmitting configuration data from one or more unit controllers to the computerized service tool device, and storing the configuration data to a memory of the computerized service tool device.

The embodiment of the method can also include, after the updating step, transmitting the configuration data from the computerized service tool device to one or more unit controllers, and storing the configuration data to a memory of the one or more unit controllers.

### BRIEF DESCRIPTION OF THE DRAWINGS

FIG. 1 illustrates an exemplary system, according to an embodiment.

FIG. 2 illustrates an exemplary flowchart, according to an embodiment.

FIG. 3 illustrates an exemplary flowchart, according to an embodiment.

FIG. 4 illustrates an exemplary flowchart, according to an embodiment.

FIGS. 5-9 illustrate exemplary embodiments of GUI of a computerized service tool device.

### DETAILED DESCRIPTION

This disclosure is directed towards devices and methods for updating a firmware of one or more UC(s) using a computerized service tool device (e.g., Technician Utility (TU)).

A BAC system having a building control network for a HVAC system can include a network using wired and/or wireless connections, interconnecting multiple BACnet devices (e.g., UCs) for controlling various heating, ventilation, and air conditioning devices of the HVAC system.

A technician can use an embodiment of the computerized service tool device for performing various tasks via the building control network. An example of the task includes maintaining and servicing the one or more UC(s). An example of the maintaining and servicing task includes updating the firmware of one or more of the UCs using the computerized service tool device. The computerized service tool device includes a specialized hardware and/or software for performing the UC firmware updating process. The computerized service tool device is configured to be able to connect (e.g., wired to or wirelessly) to a building's network for accessing and/or controlling one or more of the UCs. The computerized service tool device includes a processor and a computer readable medium which includes computer readable instructions that is executable by the processor. Examples of the computerized service tool device includes, but are not limited to, a personal computer, a mobile computer, a laptop computer, a tablet, a smart phone, etc. The computerized service tool device can run a graphical operating system (e.g., computer user interface environment), such as, for example, Windows, Unix, Mac OS, iOS, Linux, Android, etc. When the processor executes the computer readable instructions, a GUI is displayed on a display of the computerized service tool device.

The GUI of the computer readable instructions provides a user (e.g., technician) a control of the computerized service tool device for connecting to a network (e.g., BACnet network), detecting devices connected to the network (e.g., BACnet device), communicating with one or more SCs and/or UCs, and carrying out the UC firmware updating process via receiving the user's interactions via the GUI and/or according to a scheduling data stored on a memory of the TU and/or SC.

For example, the GUI provides the user with interactive elements (e.g., graphical images, icons, text, number(s), and/or combinations thereof, etc.) which can be interacted with for sending commands to transmit computer-readable files for updating one or more UC firmware, selectable by device identities, device types, etc. Accordingly, the computerized service tool device (and the GUI) provides to the user the ability to perform the UC firmware updating process of multiple UCs of the HVAC system via the network, without the necessity of physically attending to each and every UC for performing an update process.

An embodiment of the network includes a BACnet network in communication via the Internet. In some embodiments, a portion of a network may be established through, for example, a wire. A portion of the network is established wirelessly via a wireless network. In some embodiments, the wireless network may be established via or include WiFi, cellular, Bluetooth, Infrared, Radio, Microwave, and/or a mesh network (e.g., ZigBee).

BACnet is a communication protocol for building automation and control systems of, for example, a HVAC system, lighting control, access control, a fire control system, etc. The BACnet network provides a way for the devices to exchange information. For example, in a HVAC system, a SC may communicate with a plurality of UCs to retrieve information from the UCs.

The SC includes a processor, memory, and a network interface. Each UC includes a processor, memory, and a network interface. Each UC's memory can store a software configured for its operation, called a “firmware” (e.g., a binary file (“.bin”) identified by a version number) and a processor-readable configuration data which is a customizable data for operation of the UC and/or HVAC device connected to the UC. Examples of configuration data include but are not limited to identify information, network connection setup, setpoints, scheduling data, and/or other information of the UC. In an embodiment, the SC can maintain (e.g., stored in its memory) identities and other properties of the UCs that are connected to the SC via a network. The SC can make control decisions based on the information communicated from the UCs, and communicate the control decisions to the UCs. The UCs can be configured to control a variety of devices, such as air handler units, terminal equipment, and/or rooftop units. The UCs may also be configured to be able to communicate with an array of sensors to receive, for example, indoor air temperature, outdoor air temperature, pressures, and/or other measurable data useful to operating the BAC, which may be purposed for use in HVAC applications.

References are made to the accompanying drawings that form a part hereof, and in which is shown by way of illustration of the embodiments in which the methods and systems described herein may be practiced.

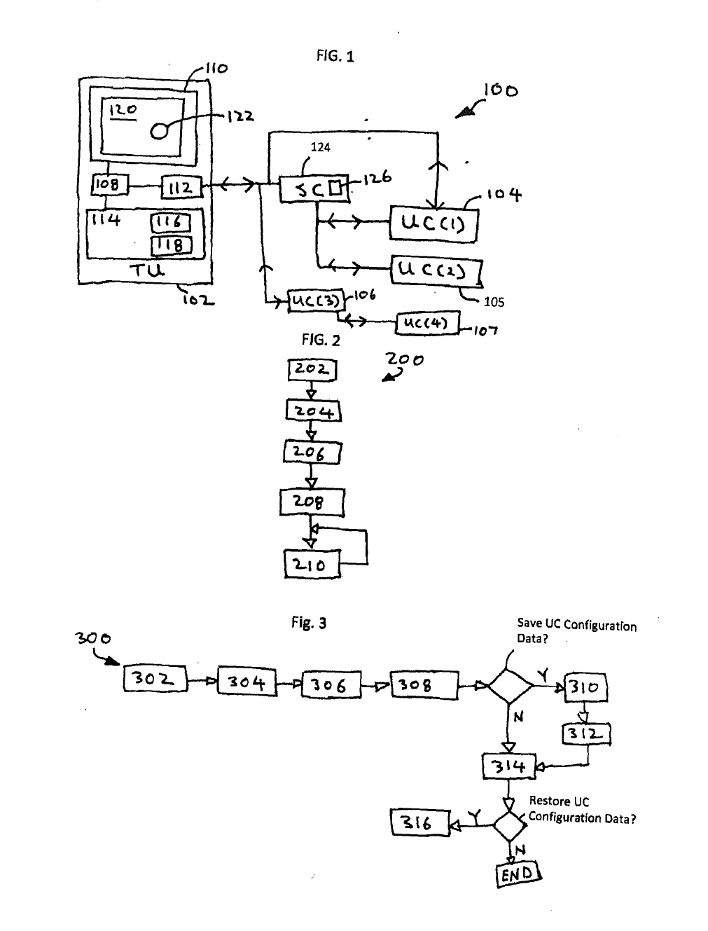

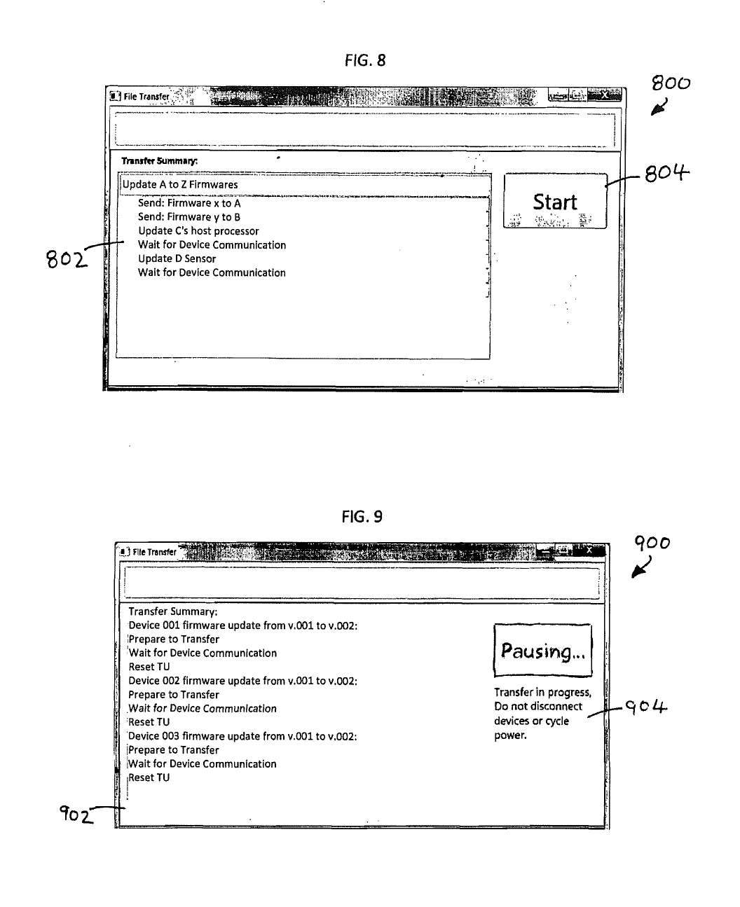

FIG. 1 illustrates an exemplary HVAC system 100 according to an embodiment of a computerized method and system for updating a firmware of one or more UC(s) 104, 105, 106, 107 using a computerized service tool device. The computerized service tool device (e.g., technician utility “TU” 102 in FIG. 1) is configured to perform a data transfer process for firmware updating of one or more UC(s) 104, 105, 106, 107 of a HVAC system 100. The TU 102 includes a processor 108, a display device 110 connected to the processor 108, a network interface 112 connected to the processor 108, and a memory 114 connected to the processor 108. The memory 114 includes a one or more versions of firmware data 116 for operation of one or more UC(s) 104, 105, 106, 107 of the HVAC system 100, and computer-readable and processor 108 executable computer instructions 118 for displaying a GUI 120 on the display device 110. The GUI 120 can display on the TU 102 interactive elements 122 for connecting to one or more devices of the HVAC system 100 via the network interface 112 for performing the firmware updating process on the one or more UC(s) 104, 105, 106, 107. The GUI 120 provides a user to use the TU 102 to transmit the firmware data 116 to the connected one or more UC(s) 104, 105, 106, 107. Advantageously, the TU 102 can update the firmware of multiple UCs 104, 105, 106, 107 to the most current versions of the firmware with a wired and/or wireless connection to the network of the HVAC system 100. The updating of the firmware of the UC(s) 104, 105, 106, 107 can be performed en masse. That is, the TU 102 (and the GUI 120) provides the user the capability of performing firmware updates to multiple UCs 104, 105, 106, 107 with a few clicks of the interactive elements 122 (e.g., GUI 800 shown in FIG. 8), and the TU 102 provides (displays) a GUI 120 feedback of the progress of the firmware updates (e.g., GUI 900 shown in FIG. 9). Advantageously, the technician does not need to physically attend to each and every UC 104, 105, 106, 107 for wiredly connecting to each UC 104, 105, 106, 107 separately, check the firmware versions of each and every UC 104, 105, 106, 107, and perform firmware update of the UC 104, 105, 106, 107 when needed. Thus, the embodied methods disclosed herein can provide advantageous time saving for the user. For example, the TU 102 can connect to a SC 124 of the HVAC system 100. The SC 124 can provide the TU 102 with a list of UC(s) to which the SC 124 is connected to (e.g., UC(1) 104 and UC(2) 105 shown in FIG. 1).

Further, for example, the TU 102 can connect to UC(1) 104. Then, the TU 102 can perform a discovery operation to gather/retrieve identification information of other device(s) (e.g., SC 124 and UC(2) 105) that is(are) also connected to the UC(1) 104.

Further, for example, the TU 102 can connect to UC(3) 106. Then, the TU 102 can perform a discovery operation to gather/retrieve identification information of other device(s) (e.g., UC(4) 107) that is(are) also connected to the UC(3) 106 for performing firmware updating operation to the UCs (e.g., UC(3) 106 and UC(4) 107).

Further, for example, the TU 102 can be used (e.g., by the user) to select which UC(s) 104, 105, 106, 107 is(are) to be updated. Based on the receipt of user's actions via the interactive elements 122 of the GUI 120 of the TU 102, one or more payload data (e.g., the firmware data 116) for the updating of the UC(s) 104, 105 can be transmitted from the TU 102 to the SC. The SC 124 can be configured by the TU 102 to perform the transmission of the one or more payload data to the one or more UC(s) 104, 105 and updates each of the firmware of the one or more UC(s) 104, 105. The method can also include transmitting an update schedule data from the TU 102 to the SC 124, wherein the transmission step is performed according to the update schedule data (e.g., by the SC 124 even after the TU 102 has been disconnected from the SC 124).

Further, prior to the updating step, customized configuration data can be transmitted from one or more UC(s) 104, 105, 106, 107 to the TU 102 (for UC(1) 104 and UC(2) 105, the customized configuration data can be transmitted to the SC 124 as an alternative), wherein the configuration data can be stored to a memory 114 of the TU 102 and/or a memory 126 of the SC 124. After the updating step, the configuration data can be transmitted back to the UC(s) 104, 105, 106, 107 from the TU 102 (via the SC 124) and/or the SC 124, so that the updated UC(s) 104, 105, 106, 107 can have the customized configuration data stored thereon. This removes the necessity of having to reconfigure the UC(s) 104, 105, 106, 107 after a firmware update has been performed.

FIG. 2 illustrates an exemplary flow diagram 200 of an embodiment of a method for updating firmware of one or more UC(s) of a HVAC system (e.g., 100 shown in FIG. 1). The flow diagram 200 includes a step 202 of the TU (e.g., 102 shown in FIG. 1) connecting to the SC (e.g., 124 shown in FIG. 1); a step 204 of the SC providing the TU with a list of UC(s) (e.g., 104, 105 shown in FIG. 1) connected to the SC (accordingly, a TU can be used to for identification of UCs en masse by connecting to just one UC); then, the TU transmitting firmware data (e.g., 116 shown in FIG. 1) to the SC; and in step 208, storing the firmware data (and scheduling instructions and/or other data related to the updating the firmware if desired by the user) to SC's memory (e.g., 126 shown in FIG. 1); and then in one or more step(s) 210 of the SC updating the firmware(s) of one or more of the UC(s) according to instructions set by the TU and stored in SC's memory (e.g., according to a set schedule, etc.).

FIG. 3 illustrates an exemplary flow diagram 300 of an embodiment of a method for updating firmware of one or more UC(s) of a HVAC system. The method includes a step 302 of using a TU to connect to a UC (e.g., UC(3) 106 shown in FIG. 1) of the HVAC system. The TU has a GUI for performing a discovery operation step 304 via the connected UC to identify and retrieve information of other unit controllers that is(are) connected to the UC via a network. For example, UC(4) 107 and/or SC 124 of FIG. 1 can be detected and identified via the TU connecting to UC(3) 106 shown in FIG. 1. Accordingly, a TU can be used to for identification of devices (e.g., UCs) en masse by connecting to just one UC. The connection information is stored 306 to a memory of the TU. The GUI of the TU displays 308 all identified UCs so that a user can select any or all identified UC(s) for performing the firmware updating process, as desired (e.g., according to the flow diagram 200 shown in FIG. 2).

Further, there can be a step 310 wherein, prior to the updating of UC(s) (e.g., as shown in FIG. 2), customized configuration data of one or more UC(s) that are related to the particular firmware (and which might be erased, deleted, and/or replaced when the firmware is updated) can be transmitted from one or more UC(s) to the TU. Then, in another step 312, the configuration data can be stored to a memory of the TU.

Then in an updating step 314, the TU can update each of the firmware of the one or more UC(s) by transmitting one or more payload data from the TU to the one or more UC(s).

After the updating step 314, there can be a reconfiguration step 316, wherein configuration data stored in the memory of the TU can be transmitted back to the UC(s) from the TU, so that the firmware updated UC(s) can have the customized configuration data stored thereon once again. The step 316 can remove the necessity of having to reconfigure the UC(s) after a firmware update has been performed.

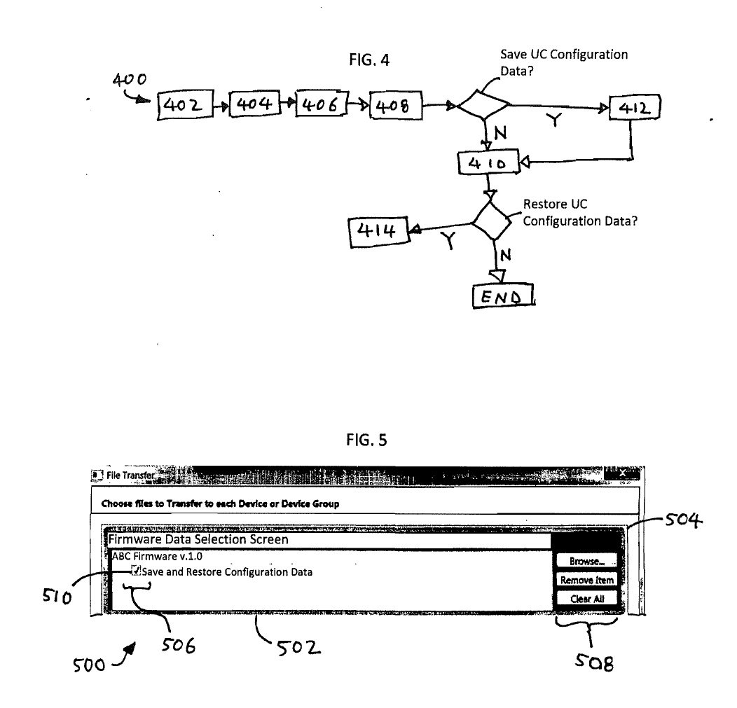

FIG. 4 illustrates an exemplary flow diagram 400 of an embodiment of a method for updating firmware of one or more UC(s) of a HVAC system. The method includes a step 402 of TU connecting a UC (e.g., UC(1) 104 shown in FIG. 1) of the HVAC system. The TU displays a GUI (e.g., 120 shown in FIG. 1) for performing a discovery operation via the UC to identify and retrieve information of a SC (e.g., 124 shown in FIG. 1) connected to the UC (e.g., 104 shown in FIG. 1) via a network. During the discovery operation step 404, the SC can be detected and identified. Upon completion 406 of the discovery operation step, the SC information stored to a memory of the TU.

The SC can provide the TU with a list of UC(s) (e.g., UC(2) 105 shown in FIG. 1) the SC is connected to. Thus, referring to FIG. 1 as an example, the TU can connect to UC(1) 104 and detect the SC 124 and then retrieve identification information about UC(2) 105.

Based on the receipt of user's actions via the interactive elements (e.g., 122 shown in FIG. 1) of the GUI of the TU, one or more payload data for the updating of the UCs can be transmitted from the TU to the SC upon a user selection of a payload data transmitting step 408.

In the updating step 410, the SC performs the transmission of the one or more payload data to the one or more UC(s) and updates each of the firmware of the one or more UC(s).

The flow diagram 400 also includes an optional step 412 of transmitting an update schedule data from the TU to the SC (which is saved in SC's memory 126 shown in FIG. 1) wherein the updating step 410 can be performed according to the update schedule data.

Further, prior to the updating step 410, customized configuration data can be transmitted from one or more UC(s) to the TU and/or SC, wherein the configuration data can be stored to a memory of the TU and/or SC (as described above and shown in FIG. 3). After the updating step 410, the configuration data can be transmitted back 414 to the UC(s) from the TU and/or SC, so that the updated UC(s) can have the customized configuration data stored thereon. This removes the necessity of having to reconfigure the UC(s) after a firmware update has been performed.

A method of updating the firmware can include a detection process, wherein one of the devices (e.g., TU and/or SC) connected to the network of the HVAC system performs a step of attempting to identify the controllers that are connected to the network. The method can also include, by one of the devices (TU and/or SC) detecting and/or determining firmware versions of the UCs (out of date determination can also be made). A GUI of the TU is configured to display one or more of the above information (e.g., list of UCs, names, firmware versions, notification that the firmware is out of date, etc.). The GUI provides interactive elements displayed on a display of the TU so that a user can select one or more UC(s), by name, by type, individually, or by group, for updating the firmware of the selected UC(s). Advantageously, the GUI and the TU provides the user with a quick list of which UCs need updating, and provides interactive elements via the GUI for the user to select which UCs are to be updated, and also optionally, an order of updating to be performed (e.g., sequence) and/or a scheduled time to begin the update. This provides the user a way of updating multiple UCs en masse via interactions with a single device (TU). The GUI can also display progress of the updates by receiving transmission progress data from the SC and/or UC(s).

FIGS. 5-9 illustrate exemplary embodiments of GUI of a computerized service tool device (e.g., TU) for performing a firmware updating process.

FIG. 5 illustrates an embodiment of a GUI 500 displayed on a display device (e.g., 110 shown in FIG. 1) of a TU (e.g., 102 shown in FIG. 1). The GUI 500 shows a window 502 displaying a firmware data selection screen 504. The firmware data can be stored on a memory (e.g., 114 shown in FIG. 1) of the TU. The GUI 500 has interactive elements 506, 508 (e.g., check boxes, Browse button, Remove item button, Clear All button, etc.) for a user to select and/or interact with, so that firmware data can be updated. The interactive elements 506, 508 can also include a selectable option 510 for saving the customized configuration data of the UC selected for the firmware upgrade.

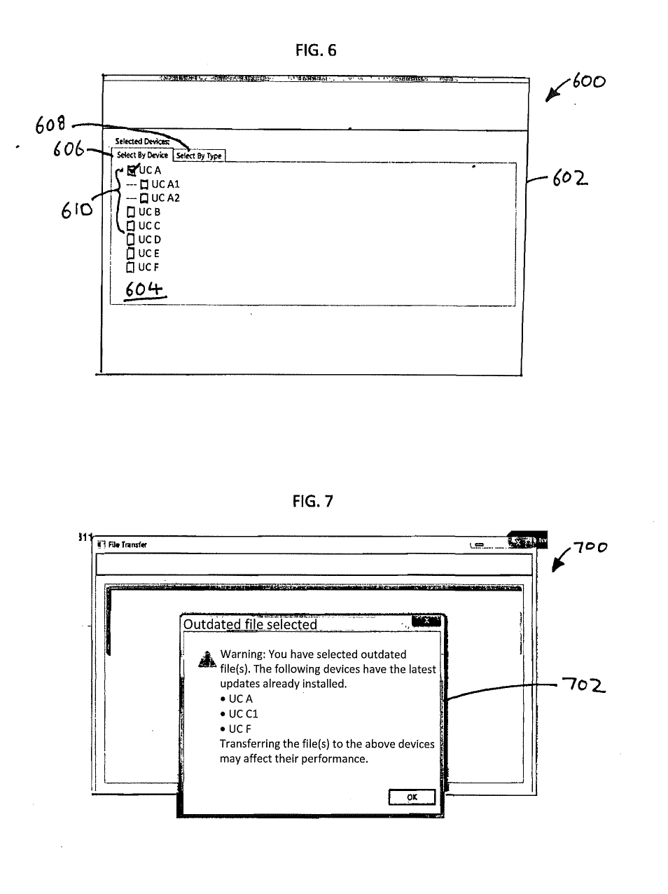

FIG. 6 illustrates an embodiment of a GUI 600 displayed on a display device (e.g., 110 shown in FIG. 1) of a TU (e.g., 102 shown in FIG. 1). The GUI 600 shows a window 602 displaying a device (UC) selection screen 604. In the selection screen 604, the detected UCs are listed by device name (for example, organized by alphabetical order, etc.). The GUI 600 includes tab interactive elements 606, 608 that allow a user to view the detected UCs by Device or by Type. The check box interactive elements 610 of the GUI 600 allows for multiple UCs to be selected for updating.

FIG. 7 illustrates an embodiment of a GUI 700 displayed on a display device (e.g., 110 shown in FIG. 1) of a TU (e.g., 102 shown in FIG. 1). The GUI 700 shows a warning window 702 which can be displayed on the display of the TU when a selected firmware version for being transmitted to a selected UC(s) (e.g., according to the GUI 600 shown in FIG. 6) is an outdated file (e.g., the firmware currently installed on the selected UC(s) is more current version).

FIG. 8 illustrates an embodiment of a GUI 800 displayed on a display device (e.g., 110 shown in FIG. 1) of a TU (e.g., 102 shown in FIG. 1). The GUI 800 shows a selected device list window 802 that is displayed on the display of the TU for a user to start the transmission of the firmware data from the TU to the SC and/or UC(s). The selected UCs are listed in the selected device list window 802. START interactive element 804 awaits a user's input, whereupon the user's interaction with the START interactive element 804, the firmware data stored in the memory of the TU is transmitted to the SC and/or UC(s).

FIG. 9 illustrates an embodiment of a GUI 900 displayed on a display device (e.g., 110 shown in FIG. 1) of a TU (e.g., 102 shown in FIG. 1). The GUI 900 shows a progress window 902 that is displayed on the display of the TU after the start of the transmission of the firmware data from the TU to the SC and/or UC(s). The GUI 900 can also include information 904, such as a warning not to disconnect the TU, a summary of the data transfers, schedule data, etc. The schedule data can include a time data of when to start updating the firmware of selected UC(s). The schedule data can include a sequential list of UCs (e.g., identification and/or names) to be updated with a new and/or different firmware. The schedule data can include a sequential order of UCs to be updated.

With regard to the foregoing description, it is to be understood that changes may be made in detail without departing from the scope of the present invention. It is intended that the specification and depicted embodiment to be considered exemplary only, with a true scope and spirit of the invention being indicated by the broad meaning of the claims.

What is claimed is:

1. A computer device for performing a data transfer process for firmware updating of one or more devices of a HVAC system via a network, comprising:
a processor;
a display device connected to the processor;
a network interface connected to the processor; and
a memory connected to the processor, the memory including:
a firmware data for operation of one or more devices of the HVAC system, and
computer-readable and processor executable computer instructions, wherein the computer-readable and processor executable computer instructions being executed by the processor displays a graphical user interface (GUI) on the display device, the GUI includes interactive elements for connecting to the one or more devices of the HVAC system via the network interface and performs a firmware updating process on the one or more devices by transmitting the firmware data to the connected one or more devices of the HVAC system.

2. The computer device as in claim 1, wherein
the processor receives identification information of the one or more devices of the HVAC system, and
the GUI displays a list of the one or more devices of the HVAC system based on the identification information received by the processor.

3. A computer implemented method for displaying a graphical user interface (GUI) on a display device of a computer device for performing a firmware updating of one or more devices of a HVAC system, the method comprising:
displaying in the GUI, one or more interactive elements for selecting the one or more devices of the HVAC system; and
displaying in the GUI, one or more interactive elements for performing the selecting the firmware updating process on the one or more devices of the HVAC system.

4. A method for updating firmware of one or more unit controllers of a HVAC system, the method comprising:
using a computerized service tool device to connect to a system controller of the HVAC system;
accessing the system controller by using the computerized service tool device and retrieving identification information of one or more unit controllers connected via a network to the system controller;
transmitting one or more payload data from the computer service tool device to the system controller;
the system controller transmitting the one or more payload data to the one or more unit controllers; and
updating each of the firmware of the one or more unit controllers with the one or more payload data.

5. The method according to claim 4, further comprising:
transmitting an update schedule data from the computer service tool device to the system controller, wherein the system controller transmitting the one or more payload data is performed according to the update schedule data.

6. The method according to claim 4, further comprising:
prior to the updating each of the firmware of the one or more unit controllers, transmitting configuration data from one or more unit controllers to the computerized service tool device, and storing the configuration data to a memory of the computerized service tool device.

7. The method according to claim 6, further comprising:
after the updating step, transmitting the configuration data from the computerized service tool device to one or more unit controllers, and storing the configuration data to a memory of the one or more unit controllers.

8. The method according to claim 6, further comprising:
after the updating step, transmitting the configuration data from the system controller to one or more unit controllers, and storing the configuration data to a memory of the one or more unit controllers.

9. The method according to claim 4, further comprising:
prior to the updating step, transmitting configuration data from one or more unit controllers to the system controller, and storing the configuration data to a memory of the system controller.

10. A computer implemented method for updating firmware of one or more unit controllers of a HVAC system, the method comprising:
connecting a computerized service tool device to a unit controller of the HVAC system;
performing a discovery operation for identifying one or more other unit controller(s) connected via a network to the connected unit controller;
storing identifying data of detected one or more unit controller(s) to a memory of the computerized service tool device; and
updating each of the firmware(s) of the detected one or more unit controller(s) by transmitting one or more payload data from the computer service tool device to the one or more unit controller(s).

11. The method according to claim 10, further comprising:
prior to the updating step, transmitting one or more configuration data from each of the one or more unit controller(s) to the computerized service tool device, and storing the configuration data to the memory of the computerized service tool device.

12. The method according to claim 11, further comprising:
after the updating step, transmitting the one or more configuration data from the memory of the computerized service tool device to the one or more unit controller(s), and storing the one or more configuration data to a memory of the one or more unit controller(s).
